(19) United States
(12) Patent Application Publication
(10) Pub. No.: US 2021/0060516 A1
(43) Pub. Date: Mar. 4, 2021

(54) METALLURGY FOR PROCESSING BIORENEWABLE FEED

(71) Applicant: UOP LLC, Des Plaines, IL (US)

(72) Inventors: Christopher M. Wozniak, Bloomingdale, IL (US); Xiaodong Liu, Hoffman Estates, IL (US); James T. Wexler, Wheaton, IL (US); Mark W. Mucek, Spring Grove, IL (US)

(21) Appl. No.: 16/559,368

(22) Filed: Sep. 3, 2019

(51) Int. Cl. B01J 19/02; C10G 69/02; C10G 45/58; C22C 38/12

(52) U.S. Cl. CPC B01J 19/02; C10G 69/02; B01J 2219/0286; C22C 38/12; C10G 45/58

(57) ABSTRACT

A process and apparatus for hydroprocessing a biorenewable feedstock involves an advantageous metallurgy. The biorenewable feed stream is hydrotreated in a hydrotreating reactor comprising a stainless steel having a composition of at least about 2 wt-% molybdenum which is sufficiently resistant to acidic corrosion. The hydrotreated biorenewable stream is hydroisomerized in a hydroisomerization reactor comprising a stainless steel having a composition of less than about 2 wt-% molybdenum. Most of the free fatty acids are deoxygenated in the hydrotreating reactor to make water, thus avoiding exposure of downstream equipment to acid attack. The stainless steel of said hydrotreating reactor may have a composition of no more than about 0.02 wt-% carbon.

### FIELD

The field is producing hydrocarbons useful as diesel boiling range fuel or aviation range fuel components from biorenewable feedstock such as triglycerides and free fatty acids found in materials such as plant and animal fats and oils.

### BACKGROUND

As the demand for fuel increases worldwide, there is increasing interest in producing fuels and blending components from sources other than crude oil. Often referred to as a biorenewable source, these sources include, but are not limited to, plant oils such as corn, rapeseed, canola, soybean, microbial oils such as algal oils, animal fats such as inedible tallow, fish oils and various waste streams such as yellow and brown greases and sewage sludge. A common feature of these sources is that they are composed of glycerides and free fatty acids (FFA). Both triglycerides and the FFAs contain aliphatic carbon chains having from about 8 to about 24 carbon atoms. The aliphatic carbon chains in triglycerides or FFAs can be fully saturated, or mono, di or poly-unsaturated. In particular, FFAs comprise considerable concentrations of unsaturated fatty acids that are susceptible to oxidation with increased temperature and concentration. Degraded FFAs lose stability and further degrade into various types of organic acids replete with protons and ions making it strongly corrosive.

Hydroprocessing can include processes which convert hydrocarbons in the presence of hydroprocessing catalyst and hydrogen to more valuable products. Hydrotreating is a process in which hydrogen is contacted with hydrocarbons in the presence of hydrotreating catalysts which are primarily active for the removal of heteroatoms, such as sulfur, nitrogen, oxygen and metals from the hydrocarbon feedstock. In hydrotreating, hydrocarbons with double and triple bonds such as olefins may be saturated.

The production of hydrocarbon products in the diesel boiling range can be achieved by hydrotreating a biorenewable feedstock. A biorenewable feedstock can be hydroprocessed by hydrotreating followed by hydroisomerization to improve cold flow properties of product diesel. Hydroisomerization or hydrodewaxing is a hydroprocessing process that increases the alkyl branching on a hydrocarbon backbone in the presence of hydrogen and hydroisomerization catalyst to improve cold flow properties of the hydrocarbon. Hydroisomerization includes hydrodewaxing herein.

To carry out the hydroprocessing operations to treat crude oil and biorenewable feedstocks to form usable products, oil refineries typically include one or more complexes or groups of equipment designed for carrying out one or more particular treating or conversion processes to prepare desired final products. In this regard, the complexes each may have a variety of interconnected units or vessels including, among others, tanks, furnaces, distillation towers, reactors, heat exchangers, pumps, pipes, fittings, and valves.

Many types of hydroprocessing operations are carried out under relatively harsh operating conditions, including high temperatures and/or pressures and within various harsh chemical environments. In addition, due to the large demands for hydrocarbon and petrochemical products, the volumetric flow rate of a hydrocarbon stream through various oil refinery complexes is substantial, and the amount of downtime of the processing equipment is preferably small to avoid losses in output.

Traditionally, austenitic stainless steels have been used to fabricate the oil refinery vessels listed above, because these types of alloys are useful in a variety of harsh environments. The addition of 8% nickel to a stainless steel containing 18% chromium produces a remarkable change in microstructure and properties. The alloy solidifies and cools to form a face-centered cubic structure called austenite, which is non-magnetic. Austenitic stainless steels are highly ductile, even at cryogenic temperatures and have excellent weldability and other fabrication properties.

Many metals, including austenitic stainless steels, can be subject to a highly localized form of corrosion known as stress-corrosion cracking (SCC). SCC often takes the form of branching cracks in apparently ductile material and can occur with little or no advance warning. In low pressure vessels, the first sign of stress corrosion cracking is usually a leak, but there have been instances of catastrophic failures of high-pressure vessels due to stress corrosion cracking. Stress corrosion cracking occurs when the surface of the material exposed to a corroding medium is under tensile stress and the corroding medium specifically causes stress corrosion cracking of the metal. Tensile stresses may be the result of applied loads, internal pressure in piping systems and pressure vessels or residual stresses from prior welding or bending.

In order for intergranular stress corrosion cracking to occur in austenitic stainless steels, typically the steel must first undergo sensitization and either concurrently or subsequently be subjected to a corrosive agent. For example, unstabilized grades of austenitic stainless steels such as Types 304 and 316, traditionally used in the fabrication of oil refinery complexes, exhibit sensitization and stress corrosion cracking. Even the stabilized grades such as Types 321 and 347 can exhibit sensitization and SCC. Typically, chromium within the austenitic stainless steels reacts with oxygen to form a passive film of chromium oxide that protects the material from corrosion. The passivated metal is able to resist further oxidation or corrosion. At high temperatures, however, usually somewhere in the range of between 370 and 815° C. depending on the stainless-steel alloy, sensitization can occur. Sensitization is when chromium-rich carbides precipitate out at the grain boundaries of the stainless steel, resulting in chromium depletion adjacent to the grain boundaries and drastically reducing the corrosion and/or cracking resistance in corrosive environments in these chromium depleted zones.

One harsh corrosive environment to which sensitized stainless steels are particularly susceptible is one that contains polythionic acid (PTA) formed from the decomposition of sulfide scale by moisture in air. PTA stress corrosion cracking (SCC) requires the combination of sulfide scale formation on the metal surface, a sensitized microstructure, tensile stress, moisture and oxygen. Due to the high temperature of operation and the presence of sulfur and hydrogen sulfide in a reducing environment or in a feed stream in many oil refinery complexes and/or processes, an iron sulfide scale can form on stainless steel surfaces. Upon shutdown of the equipment, if the sensitized stainless steel is exposed to moisture and oxygen from the surrounding environment, there is the potential that the metal can crack as a result of PTA-SCC. In other words, the sulfur and hydrogen sulfide will react with oxygen and moisture from the ambient environment to form polythionic acid. Due to the existence of the chromium depleted zones formed by sensitization, the PTA can attack these zones causing corrosion and ultimately PTA-SCC where the vessel is put under tensile stresses either by being pressurized or by having residual stresses from, for example, welding during fabrication.

Commercially, internal surfaces of refinery complex equipment for carrying out processes at elevated temperatures are usually made of Type 304 and Type 347 austenitic stainless steels, especially for use in sulfur or H₂S-containing reducing environments. Such reducing environments include, for example, hydroprocessing and hydrocracking reactors, heaters and heat exchangers. Preventing PTA formation can be accomplished by either eliminating liquid phase water or oxygen since these are the components responsible for reacting with the sulfide scale to form the PTA. One approach is to maintain the temperature of the austenitic stainless-steel equipment above the dew point of water to avoid condensation of the moisture. Another approach is to purge the equipment with a dry nitrogen purge during any shutdown or startup procedure, when the system is depressurized and the equipment is opened and exposed to air, since this is generally the only time when significant amounts of oxygen might enter the system.

PTA that has or is likely to form within a complex or vessel may be neutralized by an ammoniated nitrogen purge or an aqueous solution of soda ash. In the case of utilizing an ammoniated nitrogen purge, special procedures are utilized to form the ammoniated nitrogen, which is pressurized and blown into the system. On the other hand, a soda ash solution neutralization step involves completely filling the piping or piece of equipment involved with the solution and allowing the equipment to soak for a minimum of two hours prior to exposing the system to air. Each of these processes is time consuming and impractical during the operation of an oil refinery complex as it requires additional materials and additional downtime of the particular equipment to perform the purge or neutralization steps. In addition, due to the presence of the nitrogen, ammoniated nitrogen, or soda ash, special precautions must be taken to protect service workers working on the equipment when these materials are present. Also, the use of these chemicals increases the need for special handling and waste disposal. If trace levels of the chemicals remain, which is often the case, catalyst in the reactor can be poisoned.

Hydroprocessing of biorenewable feedstocks also can present a harsh environment that can attack sensitized grain boundaries of the stainless steel. Biorenewable feedstocks are very acidic due to their high concentration of FFAs particularly at elevated temperature. Fresh biorenewable feed to the hydroprocessing unit can have has 5-20 wt-% FFA, and even as high as 100% FFA. Moreover, the hydroprocessing of biorenewable feedstock can produce carbonic acids which also present a corrosive agent to the processing equipment. Hence, hydroprocessing of biorenewable feedstock can subject processing equipment to high rates of corrosion.

It would be desirable to provide a process and apparatus for the production of distillate hydrocarbons from a biorenewable feedstock that does not require neutralization during shut down to address sensitization and is sufficiently resistant to acidic corrosion presented by hydroprocessing of acidic biorenewable feedstocks. It would be desirable to limit the acid resistant metallurgy to the equipment in which it is necessary.

### SUMMARY

A process and apparatus for hydroprocessing a biorenewable feedstock involves an advantageous metallurgy. The biorenewable feed stream is hydrotreated in a hydrotreating reactor comprising a stainless steel having a composition of at least about 2 wt-% molybdenum which is sufficiently resistant to acidic corrosion. The hydrotreated biorenewable stream is hydroisomerized in a hydroisomerization reactor comprising a stainless steel having a composition of less than about 2 wt-% molybdenum. Most of the free fatty acids are deoxygenated in the hydrotreating reactor to make water, thus avoiding exposure of downstream equipment to acid attack. Hence, the downstream hydroisomerization reactor can be made with a stainless steel that is less resistant to acid, thereby reducing capital expense. The stainless steel of said hydrotreating reactor may have a composition of no more than about 0.02 wt-% carbon to prevent sensitization

### BRIEF DESCRIPTION OF THE DRAWING

The various embodiments will hereinafter be described in conjunction with the following FIGURE, wherein like numerals denote like elements.

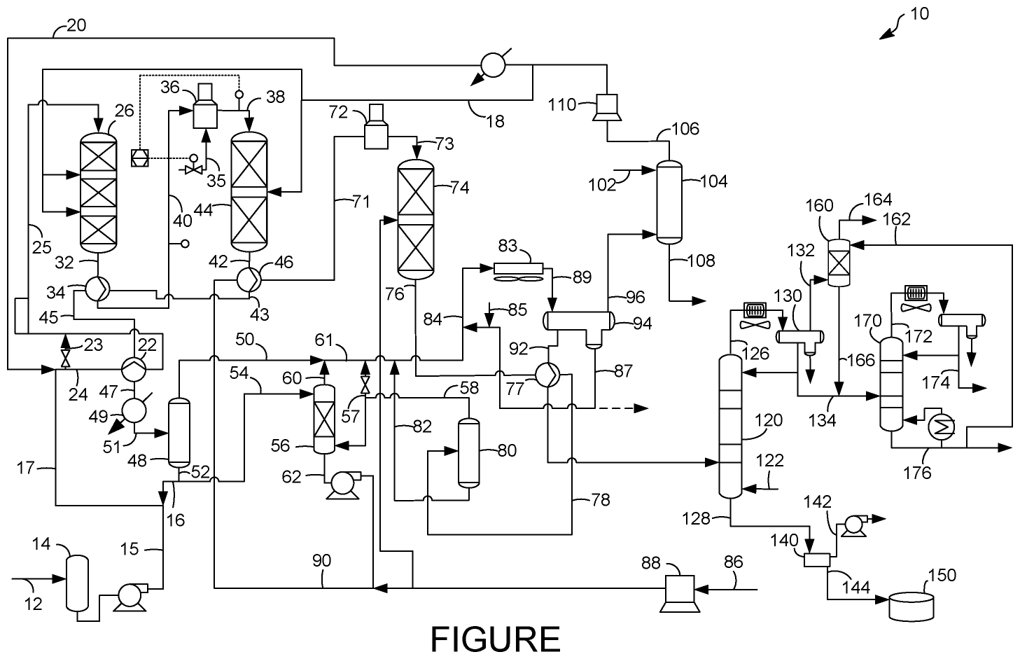

The FIG. 1s a schematic diagram of a process and an apparatus for hydroprocessing a hydrocarbon residue stream in accordance with an exemplary embodiment.

### Definitions

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without passing through a fractionation or conversion unit to undergo a compositional change due to physical fractionation or chemical conversion.

The term “indirect communication” means that flow from the upstream component enters the downstream component after passing through a fractionation or conversion unit to undergo a compositional change due to physical fractionation or chemical conversion.

The term “bypass” means that the object is out of downstream communication with a bypassing subject at least to the extent of bypassing.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take main product from the bottom.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “boiling point temperature” means atmospheric equivalent boiling point (AEBP) as calculated from the observed boiling temperature and the distillation pressure, as calculated using the equations furnished in ASTM D1160 appendix A7 entitled “Practice for Converting Observed Vapor Temperatures to Atmospheric Equivalent Temperatures”.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T5” or “T95” means the temperature at which 5 mass percent or 95 mass percent, as the case may be, respectively, of the sample boils using ASTM D-86 or TBP.

As used herein, the term “initial boiling point” (IBP) means the temperature at which the sample begins to boil using ASTM D-7169, ASTM D-86 or TBP, as the case may be.

As used herein, the term “end point” (EP) means the temperature at which the sample has all boiled off using ASTM D-7169, ASTM D-86 or TBP, as the case may be.

As used herein, the term “diesel boiling range” means hydrocarbons boiling in the range of an IBP between about 125° C. (257° F.) and about 175° C. (347° F.) or a T5 between about 150° C. (302° F.) and about 200° C. (392° F.) and the “diesel cut point” comprising a T95 between about 343° C. (650° F.) and about 399° C. (750° F.) using the TBP distillation method.

As used herein, the term “diesel conversion” means conversion of feed that boils above the diesel cut point to material that boils at or below the diesel cut point in the diesel boiling range.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” means greater than 50%, suitably greater than 75% and preferably greater than 90%.

The term “Cₓ” are to be understood to refer to molecules having the number of carbon atoms represented by the subscript “x”. Similarly, the term “Cₓ₋” refers to molecules that contain less than or equal to x and preferably x and less carbon atoms. The term “Cₓ+” refers to molecules with more than or equal to x and preferably x and more carbon atoms.

### DETAILED DESCRIPTION

Reactor metallurgy has been developed that is resistant to sensitization by reducing carbon concentration in the stainless steel. Carbon can reach a solubility limit of 0.02 wt-% at elevated temperatures allowing carbon to come out of steel solution to form carbides which can precipitate at grain boundaries leaving chromium depleted regions in the steel. The chromium depleted regions are subject to sensitization because the chromium concentration is below the 12% threshold necessary to passivate the steel. Low carbon stainless steels have been introduced with carbon concentrations below 0.03 wt-% to prolong the time necessary for sensitization. Additionally, niobium and titanium may be added to steel compositions because they have a stronger tendency to form carbides then chromium, thus allowing the chromium to stay in solution. In some stainless steels with carbon concentrations at or below 0.02 wt-%, nitrogen is also added to the steel composition to promote the high temperature strengthening characteristics lost by the reduction of the carbon concentration. Such stainless steels are resistant to sensitization, but still subject to acid attack.

Molybdenum concentration is increased to over 2 wt-% and perhaps to over 3 wt-% to provide sufficient resistance to acid attack that can be found in a hydroprocessing unit for processing biorenewable feeds which are replete with FFA's. We have discovered that the acid concentration in a process and apparatus for hydroprocessing biorenewable feeds is less concentrated at the exit of the hydrotreating reactor. Consequently, the downstream recovery and hydroisomerization reactor equipment do not require the high-molybdenum steel content enabling specification of a less expensive stainless-steel metallurgy.

In the FIGURE, in accordance with an exemplary embodiment, a process and apparatus 10 is shown for processing a biorenewable feedstock. A feed line 12 transports a feed stream of fresh biorenewable feedstock into a feed surge drum 14. The fresh biorenewable feedstock exits the feed surge drum 14 in a surge feed line 15. The biorenewable feedstock may be blended with a mineral feed stream but may comprise a predominance of biorenewable feedstock. A mineral feedstock is a conventional feed derived from crude oil that is extracted from the ground. The biorenewable feedstock may comprise a nitrogen concentration of at least about 300, perhaps about 350, suitably about 400, more suitably about 450, even about 500 wppm and perhaps even about 550 wppm nitrogen and up to about 800 wppm. The biorenewable feedstock may comprise about 1 to about 500 wppm sulfur and typically no more than about 200 wppm sulfur. The fresh biorenewable feedstock typically has about 5 to about 100 wt-% free fatty acid (FFA), typically about 10 to about 70 wt-% FFA and often about 15 to about 50 wt-% FFA depending on whether and how much is blended with conventional feed.

A variety of different biorenewable feedstocks may be suitable for the process 10. The term “biorenewable feedstock” is meant to include feedstocks other than those obtained from crude oil. The biorenewable feedstock may include any of those feedstocks which comprise at least one of glycerides and free fatty acids. Most of glycerides will be triglycerides, but monoglycerides and diglycerides may be present and processed as well. FFA's may be obtained from phospholipids which may source phosphorous in the feedstock. Examples of these biorenewable feedstocks include, but are not limited to, camelina oil, canola oil, corn oil, soy oil, rapeseed oil, soybean oil, colza oil, tall oil, sunflower oil, hempseed oil, olive oil, linseed oil, coconut oil, castor oil, peanut oil, palm oil, mustard oil, tallow, yellow and brown greases, lard, train oil, fats in milk, fish oil, algal oil, sewage sludge, and the like. Additional examples of biorenewable feedstocks include non-edible vegetable oils from the group comprising Jatropha curcas (Ratanjot, Wild Castor, Jangli Erandi), Madhuca indica (Mohuwa), Pongamia pinnata (Karanji, Honge), calophyllum inophyllum, moringa oleifera and Azadirachta indica (Neem). The triglycerides and FFAs of the typical vegetable or animal fat contain aliphatic hydrocarbon chains in their structure which have about 8 to about 30 carbon atoms. As will be appreciated, the biorenewable feedstock may comprise a mixture of one or more of the foregoing examples. The biorenewable feedstock may be pretreated to remove contaminants and filtered to remove solids.

The biorenewable feed stream in feed line 12 flows from the feed surge drum 14 via a charge pump in the surge feed line 15 and mixes with a hot recycle stream in a recycle line 16 to provide a mixed stream in a mixed line 17. The recycle to feed ratio can be about 2:1 to about 5:1. The biorenewable feedstock, perhaps blended with conventional feed, mixed with the recycle oil stream from the recycle line 16 dilutes the FFA content to a typical value of about 2 to about 33 wt-% and frequently about 5 to about 25 wt-%. A purified recycle hydrotreating hydrogen stream in a hydrotreating hydrogen line 20 is combined with the mixed biorenewable feedstock in mixed line 17 to provide a combined biorenewable feed stream in the combined line 24.

Due to the high concentration of FFA in the biorenewable feed, the stainless steel composition in the feed line 12, the feed surge drum 14, the surge feed line 15, the mixed line 17 and the combined line 24 and any equipment appurtenant thereto that contacts the feed requires metallurgy with at least about 2 wt-% and preferably at least about 3 wt-% molybdenum to resist acid attack. No more than about 7 wt-% and suitably no more than 4 wt-% molybdenum need be used in the steel composition. Moreover, upstream of the heat exchange network starting at a combined hydrotreating feed exchanger 22, stainless steel with less than 0.02 wt % carbon is not necessary due to the lack of exposure to high temperatures that would promote sensitization. The equipment upstream of the heaters for the hydrotreating reactor and appurtenant equipment that contacts the feed may have more than about 0.02 wt-% carbon. An appropriate austenitic stainless steel composition resistant to acid but not sensitization comprises about 0.02 to about 0.10 wt-% carbon, about 10 to about 30 wt-% nickel, about 15 to about 24 wt-% chromium, and about 2 to about 7 wt-% molybdenum. The balance may comprise iron. Up to 1 wt-% silicon and niobium, about 0.5 to about 5 wt % copper, and up to about 3 wt-% manganese may also be present in the acid resistant stainless steel. Stainless Steel Types 304L, 316L and 317L would be appropriate high molybdenum stainless-steel compositions that could resist the acid attack in this region of the process and apparatus.

The combined biorenewable feed stream 12 may be heated in a combined hydrotreating feed exchanger 22 by heat exchange with a hydrotreated stream in a hydrotreated line 42. The heated combined biorenewable feed stream in a heated combined feed line 25 may be then charged to an optional guard bed reactor 26 to be partially hydrotreated. The guard bed temperature may range between about 246° C. (475° F.) and about 343° C. (650° F.) to promote to foster olefin saturation, hydrodemetallation, including phosphorous removal, hydrodeoxygenation, hydrodecarbonylation and hydrodecarboxylation, hydrodesulfurization and hydrodenitrification reactions to occur.

The guard bed can comprise a base metal on a support. Base metals useable in this process include nickel, chromium, molybdenum and tungsten. Other base metals that can be used include tin, indium, germanium, lead, cobalt, gallium and zinc. The process can also use a metal sulfide, wherein the metal in the metal sulfide is selected from one or more of the base metals listed. The diluted biorenewable feedstock can be charged through these base metal or non-noble catalysts at pressures from 1379 kPa (abs) (200 psia) to 6895 kPa (abs) (1000 psia). In a further embodiment, the guard bed catalyst can comprise a second metal, wherein the second metal includes one or more of the metals: tin, indium, ruthenium, rhodium, rhenium, osmium, iridium, germanium, lead, cobalt, gallium, zinc and thallium. A nickel molybdenum on alumina catalyst may be a suitable catalyst in the guard bed reactor 26. Multiple guard beds may be contained in the guard bed reactor 26 such as two, three or more and a hydrogen quench lines from a hydrogen quench manifold 18 may be injected at interbed locations to control temperature exotherms.

A contacted biorenewable feed stream is discharged from the guard bed reactor 26 in contacted feed line 32 at a guard outlet temperature that is greater than the guard inlet temperature due to the predominant exothermic reactions that occur in the guard bed reactor 26. In the guard bed reactor 26, most of the demetallation and deoxygenation, including carbonylation and carboxylation, reactions will occur with some denitrogenation and desulfurization occurring. Metals removed include alkali metals and alkali earth metals and phosphorous.

The stainless steel composition in a feed side of the combined hydrotreating feed exchanger 22, the heated combined feed line 25, the interior of the guard bed reactor 26, the contacted feed line 32 and any equipment appurtenant thereto exposed to the contacted biorenewable feed stream should have at least about 2 wt-% and preferably at least about 3 wt-% molybdenum to resist acid attack. The temperatures in the feed side of the combined hydrotreating feed exchanger 22, the heated combined feed line 25, the interior of the guard bed reactor 26, the contacted feed line 32 and any equipment appurtenant thereto exposed to the contacted biorenewable feed stream may be around sensitization temperatures. Hence, the steel composition utilized in the equipment upstream of the combined hydrotreating feed exchanger 22 may be used if temperatures of the equipment exposed to the feed stream remain below sensitization temperatures. However, because this equipment may be exposed to sensitization temperatures at least in localized areas during upset conditions or misoperations, a stainless steel composition that is resistant to carbon precipitation that is used in the downstream hydrotreating reactor having no more than about 0.02 wt-% carbon is preferably utilized.

The contacted biorenewable feed stream in the contacted feed line 32 may still be in need of hydrotreatment to hydrodemetallate, hydrodeoxygenate, hydrodecarbonylate, hydrodecarboxylate, hydrodenitrogenate and hydrodesulfurize the contacted biorenewable feed stream in a hydrotreating reactor 44. Hence, the contacted biorenewable feed stream may be heated in a guard bed discharge heat exchanger 34 by heat exchange with the cooled hydrotreated stream in the cooled hydrotreated line 43 and transported in an intermediate hydrotreater feed line 40 to be further heated in a charge heater 36 which may be a fired heater. The charge heater 36 may increase the temperature of the contacted biorenewable feed stream to the hydrotreating inlet temperature to provide a heated, contacted biorenewable feed stream in a hydrotreater feed inlet line 38. The charge heater 36 is located between an outlet of the guard bed reactor 26 and an inlet to the hydrotreating reactor 44.

A temperature indicator controller may be used to adjust the feed rate of fuel oil or gas fed to the charge heater 36. A temperature indicator controller on the hydrotreater feed inlet line 38 can measure the temperature of the heated, contacted biorenewable feed stream and compare it to a set point perhaps in a processor or computer. If the hydrotreating inlet temperature of the heated, contacted biorenewable feed stream is higher than the set point the transmitter associated with the computer can transmit a signal to a control valve on a fuel line 35 to the charge heater 36 to reduce the flow rate of fuel oil or gas to the charge heater 36 to reduce the hydrotreating inlet temperature. If the hydrotreating inlet temperature of the heated, contacted biorenewable feed stream is lower than the set point, the transmitter associated with the computer can transmit a signal to the control valve on the fuel line 35 to the charge heater 36 to increase the flow rate of fuel oil or gas to the charge heater 36 to increase the hydrotreating inlet temperature. Other variations of the heating control mechanism are envisioned.

The heated, contacted biorenewable feed stream is charged from the hydrotreater feed inlet line 38 to a hydrotreating reactor 44. In the hydrotreating reactor 44, the heated, contacted biorenewable feed stream is contacted with a hydrotreating catalyst in the presence of hydrogen at hydrotreating conditions to saturate the olefinic or unsaturated portions of the n-paraffinic chains in the biorenewable feedstock. The hydrotreating catalyst also catalyzes hydrodeoxygenation reactions including decarboxylation and carbonylation reactions to remove oxygenate functional groups from the biorenewable feedstock molecules by converting them to water and carbon oxides. Consequently, the FFA's are converted to non-acidic species.

The stainless steel composition in the feed side of the guard bed discharge heat exchanger 34, the intermediate hydrotreater feed line 40, the feed side of the charge heater 36, the hydrotreater feed inlet line 38, the hydrotreating reactor 44 and any equipment appurtenant thereto that is exposed to the contacted biorenewable feed stream requires at least about 2 wt-% and preferably at least about 3 wt-% molybdenum to resist acid attack due to a high concentration of FFA's in the streams transported in these lines. No more than about 7 wt-% and suitably no more than about 4 wt-% molybdenum should be used in the steel composition. Additionally, the feed side of the guard bed discharge heat exchanger 34, the intermediate hydrotreater feed line 40, the feed side of the charge heater 36, the hydrotreater feed inlet line 38, the hydrotreating reactor 44 and any equipment appurtenant thereto that is exposed to the contacted biorenewable feed stream is subjected to sensitization temperatures, so the steel composition should be low in carbon such as having no more than about 0.02 wt-% carbon. An appropriate austenitic stainless steel composition resistant to acid and sensitization comprises about 0.005 to about 0.02 wt-% carbon, about 10 to about 30 wt-% nickel, about 12 to about 24 wt-% chromium, about 0.20 to about 0.50 wt-% niobium or titanium, about 0.06 to about 0.20 wt-% nitrogen, and about 2.0 to about 7 wt-% molybdenum. The balance may comprise iron. Up to about 1 wt-% silicon and up to about 3 wt-% manganese, suitably no more than about 2 wt-% manganese, about 0.5 to about 5 wt-% copper, and up to about 7 wt-% tungsten may also be present in the acid and sensitization resistant stainless steel. Stainless steel type 317 AP would be an appropriate alloy to use in this section.

When the unit is shut down for maintenance, the interior of the hydrotreating reactor 44 can be exposed to the atmosphere for at least half a day, typically at least a full day, frequently at least two days, and perhaps at least a week without concern that polythionic acid generated by contact of the sulfide scale on the interior of the reactor with moisture and oxygen will attack the grain boundaries, because too little carbon is present in the steel to permit sensitization. The refiner therefore does not have to treat the interior of the hydrotreating reactor or isolate it from the atmosphere, resulting in substantial reduction in effort and expense. The guard bed reactor 26, can also be shut down in the same way with the same advantage.

The hydrotreating catalyst may comprise nickel, nickel/molybdenum, or cobalt/molybdenum dispersed on a high surface area support such as alumina. Other catalysts include one or more noble metals dispersed on a high surface area support. Non-limiting examples of noble metals include platinum and/or palladium dispersed on an alumina support such as gamma-alumina. Suitable hydrotreating catalysts include BDO 200 or BDO 300 available from UOP LLC in Des Plaines, Ill. Generally, hydrotreating conditions include a pressure of about 700 kPa (100 psig) to about 21 MPa (3000 psig) and a hydrotreating temperature may range between about 343° C. (650° F.) and about 427° C. (800° F.) and preferably between about 349° C. (690° F.) and about 400° C. (752° F.). Two hydrotreating catalyst beds are shown in the FIGURE. The hydrotreating catalyst may be provided in one, two or more beds and employ interbed hydrogen quench streams from the hydrogen quench stream from a hydrogen quench line 18.

A hydrotreated stream is produced in a hydrotreated line 42 from the hydrotreating reactor 44 comprising a hydrocarbon fraction which has a substantial n-paraffin concentration. Oxygenate concentration in the hydrocarbon fraction is essentially nil, whereas the olefin concentration is substantially reduced relative to the contacted biorenewable feed stream. The hydrotreating catalyst also catalyzes desulfurization of organic sulfur and denitrogenation of organic nitrogen in the biorenewable feedstock. Essentially, the hydrotreating reaction removes heteroatoms from the hydrocarbons and saturates olefins in the feed stream. The organic sulfur concentration in the hydrocarbon fraction is no more than 500 wppm and the organic nitrogen concentration in the hydrocarbon fraction is less than 10 wppm.

The hydrodeoxygenation of oxygenated hydrocarbons reduces the acid species and the concentration of FFA's in the hydrotreated stream to carbon oxides and water. The carbon oxides and water in the hydrotreated line 42 and downstream thereof can produce carbonic acids. However, the carbonic acids are not as corrosive and concentrated as the FFA's in the upstream streams. Accordingly, we have found the molybdenum concentration of the stainless steels can be reduced to be less than about 2 wt-% downstream of the hydrotreating reactor.

The hydrotreated stream in the hydrotreated effluent line 42 may first flow to the combined isomerization feed exchanger 46 to heat the isomerization feed stream in the hydroisomerization feed line 90 and cool the hydrotreated stream. As previously described, the cooled hydrotreated stream in a cooled hydrotreated line 43 may then be heat exchanged with the contacted biorenewable feed stream in the guard bed discharge heat exchanger 34 to cool the hydrotreated stream in the cooled hydrotreated line 43 and heat the contacted, biorenewable feed stream. The twice cooled hydrotreated steam in a twice cooled hydrotreated line 45 may be then further cooled in the combined hydrotreating feed exchanger 22 by heat exchange with combined biorenewable feed stream in the combined feed line 24 to heat the combined biorenewable feed stream to the guard inlet temperature and further cool the twice cooled hydrotreated stream in the twice cooled hydrotreated line 45. A thrice cooled hydrotreated stream in a hot separator line 47 may be even further cooled, perhaps to make steam in a cooler 49, before it is fed to a hot separator 48 in a cooled hot separator line 51.

The stainless steel composition in the hydrotreated effluent line 42, the effluent side of the combined isomerization feed exchanger 46, the cooled hydrotreated line 43, the hydrotreated effluent side of the guard bed discharge heat exchanger 34, the twice cooled hydrotreated line 45, the effluent side of the combined hydrotreating feed exchanger 22 and perhaps the hot separator line 47, the effluent side of the cooler 49 and the cooled hot separator line 51 and any equipment appurtenant thereto that is exposed to the hydrotreated effluent stream may have less than about 2 wt-% molybdenum and perhaps at least about 1 wt-% molybdenum to resist sensitization. Moreover, because this equipment is exposed to sensitization temperatures, the stainless-steel composition should include no more than about 0.02 wt-% carbon. Stainless Steel Type 347 AP may be appropriate for the steel composition for these equipment items.

The hydrotreated stream may be separated in a hot separator 48 to provide a hydrocarbonaceous, hot vapor stream in a hot overhead line 50 and a hydrocarbonaceous, hot liquid stream in a hot bottoms line 52 having less oxygen concentration than the biorenewable feed stream. The hot separator 48 may be in downstream communication with the hydrotreating reactor 44. The hot separator 48 operates at about 177° C. (350° F.) to about 371° C. (700° F.) and preferably operates at about 232° C. (450° F.) to about 315° C. (600° F.). The hot separator 48 may be operated at a slightly lower pressure than the hydrotreating reactor 44 accounting for pressure drop through intervening equipment. The hot separator 48 may be operated at pressures between about 3.4 MPa (gauge) (493 psig) and about 20.4 MPa (gauge) (2959 psig). The hot vapor stream in the hot overhead line 50 may have a temperature of the operating temperature of the hot separator 48. In and downstream of the hot separator 48, acid attack is no longer a concern because the carbon oxides and water are in the vapor phase which is less prone to producing carbonic acid. The hot separator 48 may be constructed of steel with less than 2 wt-% molybdenum and suitably less than 1.2 wt-% molybdenum and perhaps no less than 0.05 wt-% molybdenum. Moreover, the hot separator operates under sensitization temperatures it may be constructed of steel with more than 0.3 wt-% carbon. Killed carbon steel may be used in and downstream of the hot separator 48.

The hot liquid stream in the hot bottoms line 52 may be split into two streams: a process liquid stream in a process line 54 taken from the hot liquid stream in the hot bottoms line 52 and the recycle liquid stream in the recycle line 16 also taken from the hot liquid stream in the hot bottoms line 52. The recycle liquid stream in the recycle line 16 may be combined with the biorenewable feed stream in line 12 as previously described.

The process liquid stream taken from the hot liquid stream in the process line 54 may be further separated in a hydrotreating separator 56 which may comprise an enhanced hot separator (EHS) with the aid of a stripping gas fed from an isomerization vapor line 58. The process liquid stream is separated to provide a hydrotreated vapor stream and a hydrotreated liquid stream. The hydrotreating separator 56 may be a high-pressure stripping column. In the hydrotreating separator 56, the hot process liquid stream from process line 54 flows down through the column where it is partially stripped of hydrogen, carbon dioxide, carbon monoxide, water vapor, propane, hydrogen sulfide, and phosphine, which are potential isomerization catalyst poisons, by stripping gas from the isomerization vapor line 58. The stripping gas may comprise makeup hydrogen gas which has passed through the isomerization reactor 74 and an isomerization separator 80 as hereinafter described.

The stripping gas in the isomerization vapor line 58 enters the enhanced hot separator below the inlet for the hydrotreated process liquid stream in the process liquid line 54. A bypass stream of the gas in the isomerization vapor line 58 may be diverted to a combined overhead line 61 in a bypass line 57 through a control valve. The hydrotreating separator 56 may include internals such as trays or packing located between the inlet for the hydrotreated process liquid stream in the process liquid line 54 and the inlet for the vapor hydroisomerized stream in the isomerization vapor line 58 to facilitate stripping of the liquid phase. The stripped gases in the stripping gas exit in a hydrotreated vapor stream in a hydrotreated overhead line 60 extending from a top of the hydrotreating separator 56 and mix with the hot vapor stream in the hot overhead line 50 to provide a combined overhead vapor stream in the combined overhead line 61. An isomerization liquid stream in an isomerization bottoms line 82 and optionally a cold aqueous stream in a cold aqueous line 87 from a cold separator boot to may be also mixed with the combined overhead stream in the combined overhead lie 61 provide a cold separator feed stream in a cold feed line 84.

The hydrotreated liquid stream which may have been stripped collects in the bottom of the hydrotreating separator 56 and flows in a hydrotreated bottoms line 62 to the suction side of a bottoms pump. The hydrotreated liquid stream comprises predominantly diesel range material, with a highly paraffinic concentration due to the composition of the biorenewable feedstock.

While a desired product, such as a diesel fuel, may be provided in the hydrotreated bottoms line 62, because the hot liquid stream comprises a high concentration of normal paraffins from the biorenewable feedstock, it will possess poor cold flow properties. Accordingly, to improve the cold flow properties, the hydrotreated liquid stream may be contacted with a hydroisomerization catalyst in a hydroisomerization reactor 74 under hydroisomerization conditions to hydroisomerize the normal paraffins to branched paraffins.

The hydrotreated liquid stream may be hydroisomerized over hydroisomerization catalyst in the presence of a hydroisomerization hydrogen stream. Make-up hydrogen gas in make-up line 86 may be compressed in a make-up gas compressor 88 and mixed with the hydrotreated liquid stream pumped from the hydrotreated bottoms line 62 to provide a combined hydroisomerization feed stream in a hydroisomerization feed line 90. The combined hydroisomerization feed stream in the hydroisomerization feed line 90 may be heated in a combined isomerization feed exchanger 46 by heat exchange with the hydrotreated stream in the hydrotreated line 42. The heat exchanged hydroisomerization charge stream in the heat exchanged hydroisomerization charge line 71 is heated in a hydroisomerization charge heater 72 to bring the combined hydroisomerization feed stream to isomerization temperature before charging the hydroisomerization reactor 74 in a hydroisomerization charge line 73.

The hydroisomerization, including hydrodewaxing, of the normal hydrocarbons in the hydroisomerization reactor 74 can be accomplished over one or more beds of hydroisomerization catalyst, and the hydroisomerization may be operated in a co-current mode of operation. Fixed bed, trickle bed down-flow or fixed bed liquid filled up-flow modes are both suitable. A make-up hydrogen quench stream taken from the make-up line 86 may be provided for interbed quench to the hydroisomerization reactor 74.

Suitable hydroisomerization catalysts may comprise a metal of Group VIII (IUPAC 8-10) of the Periodic Table and a support material. Suitable Group VIII metals include platinum and palladium, each of which may be used alone or in combination. The support material may be amorphous or crystalline. Suitable support materials include amorphous alumina, amorphous silica-alumina, ferrierite, ALPO-31, SAPO-11, SAPO-31, SAPO-37, SAPO-41, SM-3, MgAPSO-31, FU-9, NU-10, NU-23, ZSM-12, ZSM-22, ZSM-23, ZSM-35, ZSM-48, ZSM-50, ZSM-57, MeAPO-11, MeAPO-31, MeAPO-41, MgAPSO-11, MgAPSO-31, MgAPSO-41, MgAPSO-46, ELAPO-11, ELAPO-31, ELAPO-41, ELAPSO-11, ELAPSO-31, ELAPSO-41, laumontite, cancrinite, offretite, hydrogen form of stillbite, magnesium or calcium form of mordenite, and magnesium or calcium form of partheite, each of which may be used alone or in combination. ALPO-31 is described in U.S. Pat. No. 4,310,440. SAPO-11, SAPO-31, SAPO-37, and SAPO-41 are described in U.S. Pat. No. 4,440,871. SM-3 is described in U.S. Pat. Nos. 4,943,424; 5,087,347; 5,158,665; and 5,208,005. MgAPSO is a MeAPSO, which is an acronym for a metal aluminumsilicophosphate molecular sieve, where the metal, Me, is magnesium (Mg). Suitable MgAPSO-31 catalysts include MgAPSO-31. MeAPSOs are described in U.S. Pat. No. 4,793,984, and MgAPSOs are described in U.S. Pat. No. 4,758,419. MgAPSO-31 is a preferred MgAPSO, where 31 means a MgAPSO having structure type 31. Many natural zeolites, such as ferrierite, that have an initially reduced pore size can be converted to forms suitable for olefin skeletal isomerization by removing associated alkali metal or alkaline earth metal by ammonium ion exchange and calcination to produce the substantially hydrogen form, as taught in U.S. Pat. Nos. 4,795,623 and 4,924,027. Further catalysts and conditions for skeletal isomerization are disclosed in U.S. Pat. Nos. 5,510,306, 5,082,956, and 5,741,759. The hydroisomerization catalyst may also comprise a modifier selected from the group consisting of lanthanum, cerium, praseodymium, neodymium, samarium, gadolinium, terbium, and mixtures thereof, as described in U.S. Pat. Nos. 5,716,897 and 5,851,949. Other suitable support materials include ZSM-22, ZSM-23, and ZSM-35, which are described for use in dewaxing in U.S. Pat. No. 5,246,566 and in the article entitled S. J. Miller, “New Molecular Sieve Process for Lube Dewaxing by Wax Isomerization,” 2 Microporous Materials 439-449 (1994). U.S. Pat. Nos. 5,444,032 and 5,608,968 teach a suitable bifunctional catalyst which is constituted by an amorphous silica-alumina gel and one or more metals belonging to Group VIIIA and is effective in the hydroisomerization of long-chain normal paraffins containing more than 15 carbon atoms. U.S. Pat. Nos. 5,981,419 and 5,908,134 teach a suitable bifunctional catalyst which comprises: (a) a porous crystalline material isostructural with beta-zeolite selected from boro-silicate (BOR-B) and boro-alumino-silicate (Al—BOR—B) in which the molar SiO₂:Al₂O₃ ratio is higher than 300:1; (b) one or more metal(s) belonging to Group VIIIA, selected from platinum and palladium, in an amount comprised within the range of from 0.05 to 5% by weight. V. Calemma et al., App. Catal. A: Gen., 190 (2000), 207 teaches yet another suitable catalyst. DI-100 available from UOP LLC in Des Plaines, Ill. may be a suitable catalyst.

Hydroisomerization conditions generally include a temperature of about 150° C. (302° F.) to about 450° C. (842° F.) and a pressure of about 1724 kPa (abs) (250 psia) to about 13.8 MPa (abs) (2000 psia). In another embodiment, the hydroisomerization conditions include a temperature of about 300° C. (572° F.) to about 360° C. (680° F.) and a pressure of about 3102 kPa (abs) (450 psia) to about 6895 kPa (abs) (1000 psia).

A hydroisomerized stream in a hydroisomerized line 76 from the isomerization reactor 74 is a branched-paraffin-rich stream. By the term “rich” it is meant that the effluent stream has a greater concentration of branched paraffins than the stream entering the isomerization reactor 74, and preferably comprises greater than 50 mass-% branched paraffins of the total paraffin content. It is envisioned that the hydroisomerized effluent may contain 70, 80, or 90 mass-% branched paraffins of the total paraffin content. Only minimal branching is required, enough to improve the cold-flow properties of the hydrotreated hot liquid stream to meet specifications. Hydroisomerization conditions are selected to avoid undesirable cracking, so the predominant product in the hydroisomerized stream in the hydroisomerized line 76 is a mono-branched paraffin.

The hydroisomerized stream in the hydroisomerized line 76 from the isomerization reactor 74 flows to an isomerate exchanger 77 to be heat exchanged with a cold liquid stream in cold bottoms line 92 to cool it before entering the hydroisomerization separator 80 in a hydroisomerization separator feed line 78 for separation into a liquid hydroisomerized stream and vapor hydroisomerized stream. The vapor hydroisomerized stream in a hydroisomerized overhead line 58 extending from an overhead of hydroisomerization separator 80 flows to the hydrotreating separator 56 and may serve as the stripping gas in the hydrotreating separator as previously described. The bypass stream taken from the vapor hydroisomerized stream may optionally bypass the hydrotreating separator 56 in a bypass line 57 and enter the combined overhead line 61 through a control valve as also previously described. The hydroisomerization separator 80 operates at about 121° C. (250° F.) to about 232° C. (450° F.). “The hydroisomerization separator 80 may be operated at a slightly lower pressure than the hydroisomerization reactor 74 accounting for pressure drop through intervening equipment. The hydroisomerization separator 80 may be operated at pressures between about 3.4 MPa (gauge) (493 psig) and about 20.4 MPa (gauge) (2959 psig).

The steel composition in the charge side of the hydroisomerization charge heater 72, the hydroisomerization charge line 73, the hydroisomerization reactor 74, the hydroisomerized line 76, the effluent side of the isomerate exchanger 77 and perhaps the charge side of the isomerization feed exchanger 46, the heat exchanged hydroisomerization charge line 71 and the hydroisomerization separator feed line 78 may include more than about 0.02 wt-% carbon because sulfur is removed from the unit downstream of the hot separator 48 and the hydrotreating separator 56. Hence, in this section PTA-SCC is not a concern. Because the FFA's are removed by hydrodeoxygenation in the hydrotreating reactor 44, the molybdenum concentration in the steel of the hydroisomerization reactor may be minimized. Less than about 2 wt-molybdenum, suitably less than about 1.2 wt-% molybdenum and perhaps no less than about 0.3 wt-% molybdenum may be present in the steel composition. The internal components in the hydroisomerization reactor 74 and perhaps in the hydroisomerization charge heater 72 may comprise steel having about 5 to about 30 wt % chromium.

The liquid hydroisomerized stream in the hydroisomerization bottoms line 82 extending from a bottom of the hydroisomerization separator 80 comprising a diesel fuel may be sent directly to a stripping column 120 for producing co-products without condensing and cooling of the diesel fuel. However, the diesel fuel in the isomerization liquid stream in the isomerization bottoms line 82 from the hydroisomerization separator 80 may be further separated in a cold separator 94 along with the hot vapor stream in the hot overhead line 50 and the hydrotreated vapor stream in the hydrotreated overhead line 60 combined in combined overhead line 61. The streams in the hydroisomerization bottoms line 82 and the combined overhead line 61 may be combined with the bypass stream in bypass line 57, the cold aqueous stream in the cold aqueous line 87 to provide a cold separator stream in the cold separator feed line 84. The cold separator stream in the cold separator feed line 84 may be cooled in a cooler 83 and fed to the cold separator 94 in a cooled cold separator line 89. The aqueous stream in the cold aqueous line 87 may be obtained from the boot of the cold separator 94 and supplemented with water from a water line 85.

The alloy composition in the cold separator feed line 84, the feed side of the cooler 83, the cooled cold separator line 89, the internal surface of the cold separator 94, the cold aqueous line 87 and perhaps the water line 85 should be a corrosion resistant alloy including no less than about 40 wt-% nickel such as Alloy 625 to avoid chloride SCC that can result from chlorides in the aqueous phase.

In the cold separator 94, vaporous components in the hydroisomerized liquid stream will separate and ascend with the hydrotreated vapor stream and the hot vapor stream to provide a cold vapor stream in a cold overhead line 96. The cold vapor stream in the cold overhead line 96 may be passed through a trayed or packed recycle scrubbing column 104 where it is scrubbed by means of a scrubbing liquid such as an aqueous solution fed by scrubbing liquid line 102 to remove acid gases including hydrogen sulfide and carbon dioxide by extracting them into the aqueous solution. Preferred scrubbing liquids include Selexol™ available from UOP LLC in Des Plaines, Ill. and amines such as alkanolamines including diethanol amine (DEA), monoethanol amine (MEA), methyl diethanol amine (MDEA), diisopropanol amine (DIPA), and diglycol amine (DGA). Other scrubbing liquids can be used in place of or in addition to the preferred amines. The lean scrubbing liquid contacts the cold vapor stream and absorbs acid gas contaminants such as hydrogen sulfide and carbon dioxide. The resultant “sweetened” cold vapor stream is taken out from an overhead outlet of the recycle scrubber column 104 in a recycle scrubber overhead line 106, and a rich scrubbing liquid is taken out from the bottoms at a bottom outlet of the recycle scrubber column 104 in a recycle scrubber bottoms line 108. The spent scrubbing liquid from the bottoms may be regenerated and recycled back to the recycle scrubbing column 104 in the scrubbing liquid line 102. The scrubbed hydrogen-rich stream emerges from the scrubber via the recycle scrubber overhead line 106 and may be compressed in a recycle compressor 110.

The compressed hydrogen stream in the scrubber overhead line 106 supplies hydrogen to the hydrotreating hydrogen stream in the hydrotreating hydrogen line 20 and interbed quench streams from a quench line 18 in the guard bed reactor 26 and a hydrotreating reactor 44.

The recycle scrubbing column 104 may be operated with a gas inlet temperature between about 38° C. (100° F.) and about 66° C. (150° F.) and an overhead pressure of about 3 MPa (gauge) (435 psig) to about 20 MPa (gauge) (2900 psig). Suitably, the recycle scrubbing column 104 may be operated at a temperature of about 40° C. (104° F.) to about 125° C. (257° F.) and a pressure of about 1200 to about 1600 kPa. The temperature of the hot vapor stream to the recycle scrubbing column 104 may be between about 20° C. (68° F.) and about 80° C. (176° F.) and the temperature of the scrubbing liquid stream in the scrubbing liquid line 102 may be between about 20° C. (68° F.) and about 70° C. (158° F.).

The cold liquid stream in cold bottoms line 92 comprises hydrocarbons useful as diesel boiling range fuel as well as other hydrocarbons such as propane, naphtha and aviation fuel. Accordingly, they may be stripped in a stripping column 120. The cold liquid stream in the cold bottoms line 92 may be heated by heat exchange in the isomerate exchanger 77 with a hydroisomerized stream in the hydroisomerized line 76 to heat the cold liquid stream and fed to the stripping column 120 from an inlet which may be in a bottom half of the column. The stripping column 120 may be reboiled by heat exchange with a suitable hot stream or in a fired heater to provide the necessary stripping vapor (not shown). Alternately, a stripping media which is an inert gas such as steam from a stripping media line 122 may be used to heat the column, but the stripped product may require drying to meet product water specifications. The stripping column 120 provides an overhead stripper gaseous stream of naphtha, LPG, hydrogen, hydrogen sulfide, steam and other gases in an overhead line 126 and a stripped liquid stream in a stripper bottoms line 128. The cold overhead stripper gaseous stream may be condensed and separated in a receiver 130. A net stripper overhead line 132 from the receiver 130 may carry a net stripper gaseous stream to a sponge absorber for LPG recovery. Unstabilized liquid naphtha from the bottoms of the receiver 130 may be split between a reflux portion refluxed to the top of the cold stripping column 120 and a stripper liquid overhead stream which may be transported a debutanizer column for naphtha and LPG recovery in a stripper receiver bottoms line 134. A sour water stream may be collected from a boot of the overhead receiver 130.

The stripping column 120 may be operated with a bottoms temperature between about 149° C. (300° F.) and about 288° C. (550° F.), preferably no more than about 260° C. (500° F.), and an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 130 ranges from about 38° C. (100° F.) to about 66° C. (150° F.) and the pressure is essentially the same as in the overhead of the stripping column 120.

The sponge absorber column 160 may receive the net stripper gaseous stream in the net stripper overhead line 132. A lean absorbent stream in a lean absorbent line 162 may be fed into the sponge absorber column 160 through an absorbent inlet. The lean absorbent may comprise a naphtha stream in a lean absorbent line 162 perhaps from a debutanizer bottoms line 176. In the sponge absorber column 160, the lean absorbent stream and the net stripper gaseous stream are counter-currently contacted. The sponge absorbent absorbs LPG hydrocarbons from the net stripper gaseous stream into an absorbent-rich stream.

The hydrocarbons absorbed by the sponge absorbent include some methane and ethane and most of the LPG, C3 and C4, hydrocarbons, and any C₅ and C₆₊ light naphtha hydrocarbons in the net stripper gaseous stream. The sponge absorber column 160 operates at a temperature of about 34° C. (93° F.) to 60° C. (140° F.) and a pressure essentially the same as or lower than the stripping receiver 130 less frictional losses. A sponge absorption off gas stream depleted of LPG hydrocarbons is withdrawn from a top of the sponge absorber column 160 at an overhead outlet through a sponge absorber overhead line 164. The sponge absorption off gas stream in the sponge absorber overhead line 164 may be transported to a hydrogen recovery unit that is not shown for hydrogen recovery. A rich absorbent stream rich in LPG hydrocarbons is withdrawn in a rich absorber bottoms line 166 from a bottom of the sponge absorber column 160 at a bottoms outlet which may be fed to a debutanizer column 170 via the stripper liquid overhead stream in the stripper receiver bottoms line 134.

In an embodiment, the debutanizer column 170 may fractionate the stripper liquid overhead stream and the rich absorbent stream in the stripper receiver bottoms line 134 into a debutanized bottoms stream comprising predominantly C₅₊ hydrocarbons and a debutanizer overhead stream comprising LPG hydrocarbons. The debutanizer overhead stream in a debutanizer overhead line 172 may be fully condensed with reflux to the debutanizer column 170 and recovery of LPG in a debutanized overhead liquid stream in a net receiver bottoms line 174. The debutanized bottoms stream may be withdrawn from a bottom of the debutanizer column 170 in a debutanized bottoms line 176. A reboil stream taken from a bottom of the debutanizer column 170 or from a debutanized bottoms stream in the debutanizer bottoms line 176 may be boiled up in the reboil line and sent back to the debutanizer column 170 to provide heat to the column. Alternatively, a hot inert media stream such as steam may be fed to the column 170 to provide heat to the column.

The stripped liquid stream in the stripper bottoms line 128 may comprise green diesel boiling range hydrocarbons. Consequently, the liquid stream in stripper bottoms line 128 may be dried and fed to a diesel pool 150. For example, the stripped liquid stream may be dried in a vacuum drier 140 operated below atmospheric pressure. The stripped liquid stream in the stripper bottoms line 128 may be fed to the vacuum drier 140 which may include a vacuum pump in communication with a vent stream 142 which pulls a vacuum on the stripped liquid stream entering the vacuum drier 140 in the stripper bottoms line 128. The water in the stripped liquid stream will be removed in the gas stream 142. A dried green diesel stream with a lower water concentration than in the stripped liquid stream may be removed from the vacuum drier in a drier bottoms line 144 and forwarded to the diesel pool 150.

The process and apparatus 10 utilize metallurgy that enables hydroprocessing of a biorenewable feed stream that adequately protects against free fatty acid attack where it is needed recognizing that high concentration of FFA is not encountered downstream of the hydrotreating reactor. The metallurgy also protects against sensitization where such temperatures are to be encountered.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### Specific Embodiments

While the following is described in conjunction with specific embodiments, it will be understood that this description is intended to illustrate and not limit the scope of the preceding description and the appended claims.

A first embodiment of the disclosure is a process for hydroprocessing a biorenewable feedstock, the process comprising hydrotreating a biorenewable feed stream in a hydrotreating reactor in the presence of hydrogen to saturate olefins, deoxygenate oxygenated hydrocarbons and demetallize metallized hydrocarbons to produce a hydrotreated stream, the hydrotreating reactor comprising a stainless steel having a composition of at least about 2 wt-% molybdenum; and hydroisomerizing the hydrotreated stream in a hydroisomerization reactor over a hydroisomerization catalyst in the presence of a hydroisomerization hydrogen stream to provide a hydroisomerized stream, the hydroisomerization reactor comprising a steel having a composition of less than about 2 wt-% molybdenum. An embodiment of the disclosure is one, any or all of prior embodiments in this paragraph up through the first embodiment in this paragraph wherein the steel of the hydroisomerization reactor has a composition of no more than about 1.2 wt-% molybdenum. An embodiment of the disclosure is one, any or all of prior embodiments in this paragraph up through the first embodiment in this paragraph wherein the steel of the hydroisomerization reactor has a composition of no less than about 0.3 wt-% molybdenum. An embodiment of the disclosure is one, any or all of prior embodiments in this paragraph up through the first embodiment in this paragraph wherein the stainless steel of the hydrotreating reactor has a composition of at least about 3 wt-% molybdenum. An embodiment of the disclosure is one, any or all of prior embodiments in this paragraph up through the first embodiment in this paragraph wherein the stainless steel of the hydrotreating reactor has a composition of no more than about 7 wt-% molybdenum. An embodiment of the disclosure is one, any or all of prior embodiments in this paragraph up through the first embodiment in this paragraph further comprising shutting down the hydrotreating reactor and exposing the interior of the reactor to the atmosphere for at least half a day. An embodiment of the disclosure is one, any or all of prior embodiments in this paragraph up through the first embodiment in this paragraph further comprising feeding the hydrotreated stream to a separator to separate the hydrotreated stream into a liquid hydrotreated stream and a vapor hydrotreated stream; the separator reactor comprising a steel having a composition of less than about 2 wt-% molybdenum. An embodiment of the disclosure is one, any or all of prior embodiments in this paragraph up through the first embodiment in this paragraph further comprising discharging the hydrotreated stream from the hydrotreating reactor in a hydrotreated effluent line, the hydrotreated effluent line comprising a steel having a composition of less than about 2 wt-% molybdenum. An embodiment of the disclosure is one, any or all of prior embodiments in this paragraph up through the first embodiment in this paragraph wherein the stainless steel of the hydrotreating reactor has a composition of no more than about 0.02 wt-% carbon. An embodiment of the disclosure is one, any or all of prior embodiments in this paragraph up through the first embodiment in this paragraph wherein the stainless steel of the hydroisomerization reactor has a composition of more than about 0.02 wt-% carbon. An embodiment of the disclosure is one, any or all of prior embodiments in this paragraph up through the first embodiment in this paragraph further comprising contacting the biorenewable feed stream in a guard bed reactor in the presence of hydrogen to saturate olefins and demetallize metallized hydrocarbons upstream of the hydrotreating reactor to produce a contacted biorenewable feed stream, the guard bed reactor comprising a stainless steel having a composition of at least about 2 wt-% molybdenum.

A second embodiment of the disclosure is an apparatus for hydroprocessing a biorenewable feed stream comprising a hydrotreating reactor comprising a stainless steel having a composition of at least about 2 wt-% molybdenum; and a hydroisomerization reactor in downstream communication with the hydrotreating reactor, the hydroisomerization reactor comprising a stainless steel having a composition of less than about 2 wt-% molybdenum. An embodiment of the disclosure is one, any or all of prior embodiments in this paragraph up through the second embodiment in this paragraph wherein the stainless steel of the hydroisomerization reactor has a composition of no more than about 1.2 wt-% molybdenum. An embodiment of the disclosure is one, any or all of prior embodiments in this paragraph up through the second embodiment in this paragraph wherein the stainless steel of the hydroisomerization reactor has a composition of no less than about 0.3 wt-% molybdenum. An embodiment of the disclosure is one, any or all of prior embodiments in this paragraph up through the second embodiment in this paragraph wherein the stainless steel of the hydrotreating reactor has a composition of at least about 3 wt-% molybdenum. An embodiment of the disclosure is one, any or all of prior embodiments in this paragraph up through the second embodiment in this paragraph wherein the stainless steel of the hydrotreating reactor has a composition of no more than about 7 wt-% molybdenum. An embodiment of the disclosure is one, any or all of prior embodiments in this paragraph up through the second embodiment in this paragraph further comprising a separator in downstream communication with the hydrotreating reactor and the hydroisomerization reactor in downstream communication with the separator; the separator reactor comprising a steel having a composition of less than about 2 wt-% molybdenum. An embodiment of the disclosure is one, any or all of prior embodiments in this paragraph up through the second embodiment in this paragraph further comprising a hydrotreated effluent line connecting to the hydrotreating reactor, the hydrotreated effluent line comprising a steel having a composition of less than about 2 wt-% molybdenum.

A third embodiment of the disclosure is an apparatus for hydroprocessing a biorenewable feed stream comprising a hydrotreating reactor comprising a stainless steel having a composition of at least about 2 wt-% molybdenum; a separator in downstream communication with the hydrotreating reactor, the separator comprising a stainless steel having a composition of less than about 2 wt-% molybdenum and a hydroisomerization reactor in downstream communication with the separator, the hydroisomerization reactor comprising a steel having a composition of less than about 2 wt-% molybdenum. An embodiment of the disclosure is one, any or all of prior embodiments in this paragraph up through the third embodiment in this paragraph further comprising a guard bed reactor in upstream communication with hydrotreating reactor, the guard bed reactor comprising a stainless steel having a composition of at least about 2 wt-% molybdenum.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for hydroprocessing a biorenewable feedstock, the process comprising:
hydrotreating a biorenewable feed stream in a hydrotreating reactor in the presence of hydrogen to saturate olefins, deoxygenate oxygenated hydrocarbons and demetallize metallized hydrocarbons to produce a hydrotreated stream, said hydrotreating reactor comprising a stainless steel having a composition of at least about 2 wt-% molybdenum; and
hydroisomerizing the hydrotreated stream in a hydroisomerization reactor over a hydroisomerization catalyst in the presence of a hydroisomerization hydrogen stream to provide a hydroisomerized stream, said hydroisomerization reactor comprising a steel having a composition of less than about 2 wt-% molybdenum.

2. The process of claim 1 wherein the steel of said hydroisomerization reactor has a composition of no more than about 1.2 wt-% molybdenum.

3. The process of claim 2 wherein the steel of said hydroisomerization reactor has a composition of no less than about 0.3 wt-% molybdenum.

4. The process of claim 1 wherein the stainless steel of said hydrotreating reactor has a composition of at least about 3 wt-% molybdenum.

5. The process of claim 1 wherein the stainless steel of said hydrotreating reactor has a composition of no more than about 7 wt-% molybdenum.

6. The process of claim 1 further comprising shutting down the hydrotreating reactor and exposing the interior of the reactor to the atmosphere for at least half a day.

7. The process of claim 1 further comprising feeding said hydrotreated stream to a separator to separate said hydrotreated stream into a liquid hydrotreated stream and a vapor hydrotreated stream; said separator reactor comprising a steel having a composition of less than about 2 wt-% molybdenum.

8. The process of claim 1 further comprising discharging the hydrotreated stream from the hydrotreating reactor in a hydrotreated effluent line, said hydrotreated effluent line comprising a steel having a composition of less than about 2 wt-% molybdenum.

9. The process of claim 1 wherein the stainless steel of said hydrotreating reactor has a composition of no more than about 0.02 wt-% carbon.

10. The process of claim 1 wherein the stainless steel of said hydroisomerization reactor has a composition of more than about 0.02 wt-% carbon.

11. The process of claim 1 further comprising contacting said biorenewable feed stream in a guard bed reactor in the presence of hydrogen to saturate olefins and demetallize metallized hydrocarbons upstream of said hydrotreating reactor to produce a contacted biorenewable feed stream, said guard bed reactor comprising a stainless steel having a composition of at least about 2 wt-% molybdenum.

12. An apparatus for hydroprocessing a biorenewable feed stream comprising a hydrotreating reactor comprising a stainless steel having a composition of at least about 2 wt-% molybdenum; and a hydroisomerization reactor in downstream communication with said hydrotreating reactor, said hydroisomerization reactor comprising a stainless steel having a composition of less than about 2 wt-% molybdenum.

13. The apparatus of claim 12 wherein the stainless steel of said hydroisomerization reactor has a composition of no more than about 1.2 wt-% molybdenum.

14. The apparatus of claim 13 wherein the stainless steel of said hydroisomerization reactor has a composition of no less than about 0.3 wt-% molybdenum.

15. The apparatus of claim 12 wherein the stainless steel of said hydrotreating reactor has a composition of at least about 3 wt-% molybdenum.

16. The apparatus of claim 12 wherein the stainless steel of said hydrotreating reactor has a composition of no more than about 7 wt-% molybdenum.

17. The apparatus of claim 12 further comprising a separator in downstream communication with said hydrotreating reactor and said hydroisomerization reactor in downstream communication with said separator; said separator reactor comprising a steel having a composition of less than about 2 wt-% molybdenum.

18. The apparatus of claim 1 further comprising a hydrotreated effluent line connecting to said hydrotreating reactor, said hydrotreated effluent line comprising a steel having a composition of less than about 2 wt-% molybdenum.

19. An apparatus for hydroprocessing a biorenewable feed stream comprising a hydrotreating reactor comprising a stainless steel having a composition of at least about 2 wt-% molybdenum; a separator in downstream communication with said hydrotreating reactor, said separator comprising a stainless steel having a composition of less than about 2 wt-% molybdenum and a hydroisomerization reactor in downstream communication with said separator, said hydroisomerization reactor comprising a steel having a composition of less than about 2 wt-% molybdenum.

20. The apparatus of claim 19 further comprising a guard bed reactor in upstream communication with hydrotreating reactor, said guard bed reactor comprising a stainless steel having a composition of at least about 2 wt-% molybdenum.
